(19) United States
(12) Patent Application Publication
(10) Pub. No.: US 2009/0097554 A1
(43) Pub. Date: Apr. 16, 2009

(54) METHODS AND APPARATUS TO MANAGE A BONDED DIGITAL SUBSCRIBER LINE (DSL) SERVICE

(76) Inventors: Raghvendra Savoor, Walnut Creek, CA (US); Haibo Zhang, San Jose, CA (US); Jin Wang, Fremont, CA (US); Hua Jiao, San Ramon, CA (US)

Correspondence Address: AT&T Legal Department - HFZ;ATTN. Patent Docketing, One AT&T Way, Room 2A-207, Bedminstor, NJ, 07921, US

(21) Appl. No.: 11/870,236

(22) Filed: Oct. 10, 2007

(51) Int. Cl. H04N 11/02

(52) U.S. Cl. 375/240.08

(57) ABSTRACT

Methods and apparatus to manage a bonded digital subscriber line (DSL) service are disclosed. A disclosed example method comprises collecting data representative of bandwidth usage for two or more applications serviced by a bonded set of subscriber lines; analyzing historical activity of the two or more applications based on the collected bandwidth usage data; and selecting a first digital subscriber line (DSL) line profile for a first wire pair in the set of subscriber lines, the set of subscriber lines forming a single DSL communication link.

### FIELD OF THE DISCLOSURE

This disclosure relates generally to digital subscriber line (DSL) services and/or systems and, more particularly, to methods and apparatus to manage a bonded DSL service.

### BACKGROUND

Communication systems using digital subscriber line (DSL) technologies are commonly utilized to provide Internet related services to subscribers, such as, for example, homes and/or businesses (also referred to herein as users, customers and/or customer premises). DSL technologies enable customers to utilize telephone lines (e.g., ordinary twisted-pair copper telephone lines used to provide Plain Old Telephone System (POTS) services) to connect the customer to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) at a central office (CO) to provide DSL communication services to a plurality of modems located at respective customer premises. In general, a CO DSL modem receives broadband service content from, for example, a backbone server and forms a digital downstream DSL signal to be transmitted to a customer-premises DSL modem. Likewise, the central office DSL modem receives an upstream DSL signal from the customer-premises DSL modem and provides the data transported in the upstream DSL signal to the backbone server. Bonded DSL technologies and/or bonded DSL services utilize two or more subscriber lines communicatively coupled between a DSLAM and a single customer premises to form a high data-rate aggregate DSL communication path. In bonded DSL services, a user's data is split, and the portions of the user's data are transmitted on different subscriber lines. Such an aggregate DSL communication path is capable of delivering higher data rate and/or a larger number of simultaneous communication services to the customer premises. For example, a bonded DSL service using two subscriber lines may be used to enable the delivery of multiple (e.g., three) simultaneous high-definition video streams.

### BRIEF DESCRIPTION OF THE DRAWINGS

FIG. 1 is a schematic illustration of an example digital subscriber line (DSL) communication system constructed in accordance with the teachings of the disclosure.

FIGS. 2A and 2B illustrate example data structures that may be used to implement the example host table of FIG. 1.

FIG. 3 illustrates an example manner of implementing the example profile manager of FIG. 1.

FIG. 4 is a flowchart representative of example machine accessible instructions that may be carried out by, for example, a processor to implement any or all of the example profile managers of FIGS. 1 and/or 3.

FIG. 5 is a flowchart representative of example machine accessible instructions that may be carried out by, for example, a processor to implement the example application layer logger of FIG. 1.

FIG. 6 is a schematic illustration of an example processor platform that may be used and/or programmed to execute the example machine accessible instructions of FIGS. 4 and/or 5 to implement any or all of the example profile managers and/or application layer loggers described herein.

### DETAILED DESCRIPTION

Methods and apparatus to manage a bonded digital subscriber line (DSL) service are disclosed. A disclosed example method includes collecting data representative of bandwidth usage for two or more applications serviced by a bonded set of subscriber lines; analyzing historical activity of the two or more applications based on the collected bandwidth usage data; and selecting a first digital subscriber line (DSL) line profile for a first wire pair in the set of subscriber lines, the set of subscriber lines forming a single DSL communication link.

A disclosed example apparatus includes a data collection server to collect bandwidth usage data for two or more applications delivered by a bonded set of subscriber lines; and a profile selector to select a first digital subscriber line (DSL) line profile for a first wire pair in the bonded set and a second DSL line profile for a second wire pair in the bonded set based on the collected bandwidth usage data, the bonded set forming a single DSL communication link.

In the interest of brevity and clarity, throughout the following disclosure references will be made to connecting a digital subscriber line (DSL) modem and/or a DSL communication service to a customer premises, customer and/or subscriber. However, it will be readily apparent to persons of ordinary skill in the art that connecting a DSL modem to a customer premises, customer and/or subscriber involves, for example, connecting a first DSL modem operated by a communications company (e.g., a central office (CO) DSL modem implemented by a DSL access multiplexer (DSLAM)) to a second DSL modem located at, for example, a customer premises (e.g., a home and/or place of business owned, leased and/or operated by a customer) via a twisted-pair telephone line (i.e., a subscriber line). The customer premises (e.g., the second) DSL modem may be further connected to other communication and/or computing devices (e.g., a personal computer, a set-top box, a phone, etc.) that the customer uses and/or operates to access a service (e.g., Internet access, Internet protocol (IP) Television (TV), voice over Internet Protocol (VoIP), etc.) via the CO DSL modem, the customer-premises DSL modem, the subscriber line and the communications company.

Moreover, while methods and apparatus to manage a bonded DSL service are described herein, the example methods and apparatus may, additionally or alternatively, be used to test other wires and/or cables for other communication services. Other example wires and/or cables include, but are not limited to, those associated with public switched telephone network (PSTN) systems, public land mobile network (PLMN) systems (e.g., cellular), wireless distribution systems, wired or cable distribution systems, coaxial cable distribution systems, Ultra High Frequency/Very High Frequency radio frequency systems, satellite or other extra-terrestrial systems, cellular distribution systems, passive optical networks, power-line broadcast systems, fiber optic networks, and/or any combination and/or hybrid of these devices, systems and/or networks.

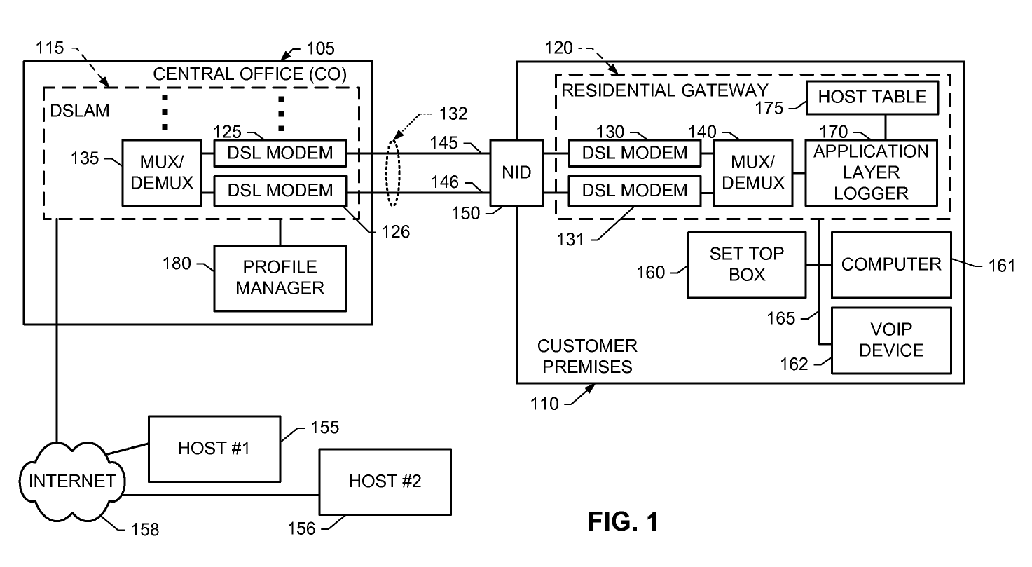

FIG. 1 illustrates an example DSL communication system in which a central office (CO) 105 provides data and/or communication services (e.g., telephone services, Internet services, data services, messaging services, instant messaging services, electronic mail (email) services, chat services, video services, audio services, gaming services, etc.) to one or more customer premises, one of which is designated at reference numeral 110. To provide DSL communication services to the customer premises 110, the example CO 105 of FIG. 1 includes any number and/or type(s) of DSLAMs (one of which is designated at reference numeral 115), and the example customer premises 110 includes any type of residential gateway 120. The example DSLAM 115 of FIG. 1 includes and/or implements CO DSL modems (two of which are designated with reference numerals 125 and 126) for respective ones of customer premises equipment (CPE) DSL modems (two of which are implemented by the example residential gateway 120, and are designated at reference numerals 130 and 131). In the illustrated example of FIG. 1. the example CO DSL modems 125 and 126 and the example CPE DSL modems 130 and 131 together implement a bonded DSL service between the example CO 105 and the example customer premises 110. However, the example DSLAM 115 may, additionally or alternatively, provide non-bonded DSL services to other customer premises (e.g. via a single CO DSL modem paired with a single CPE modem).

In general, bonded DSL services facilitate the combining of the data transport capabilities of two or more subscriber lines used for DSL to form a single aggregate DSL path 132 between a service provider and a single subscriber. Bonding of subscriber lines facilitates an increase in data rate in approximate proportion to the number of lines that are bonded. To combine and/or split user data, the example DSLAM 115 of FIG. 1 includes and/or implements a multiplexer (mux)/de-multiplexer (demux) 135, and the example residential gateway 120 includes a corresponding mux/demux 140. The example mux/demux 135 of FIG. 1 splits a stream of user data directed to the customer premises 110 via the aggregate DSL path 132 into two sub-streams of data, with each of the sub-streams transported to the customer premises 110 via a respective CO DSL modem 125, 126. At the example CPE mux/demux 140 of FIG. 1, user data sub-streams received via respective CPE modems 130 and 131 are (re-)combined to form the original user data stream (assuming no errors occurred during transmission). Data directed to the CO 105 via the aggregrate DSL path 132 is likewise split by the mux/demux 140 and (re-)combined by the mux/demux 135. The example DSLAM 115, the example CO DSL modems 125 and 126, the example DSL modems 130 and 131 and/or the aggregate DSL path 132 of FIG. 1 may be implemented, for example, in accordance with the Telecommunication Sector of the International Telecommunications Union (ITU-T) G.993.x family of recommendations for very high-speed DSL (VDSL) and/or the ITU-T G.998.x family of recommendations for bonded DSL services.

In the illustrated example of FIG. 1, the DSLAM 115 provides the bonded DSL service 132 to the customer premises 110 via two subscriber lines 145 and 146. The example subscriber line 145 communicatively couples the CO DSL modem 125 to the CPE DSL modem 130, and the example subscriber line 146 communicatively couples the CP DSL modem 126 to the CPE DSL modem 131. Subscriber lines are sometimes also referred to in the industry as “wire-pairs” and/or “loops.” While throughout this disclosure reference is made to the example subscriber lines 145 and 146 of FIG. 1, a subscriber line (e.g., either or both of the example subscriber lines 145 and 146) used to provide a DSL service to a customer premises location (e.g., the location 110) may include and/or be constructed from one or more segments of twisted-pair telephone wire (e.g., a combination of a feeder one (F1) cable, a distribution cable, a drop cable, and/or customer-premises wiring), terminals and/or distributions points (e.g., a serving area interface (SAI), a serving terminal, a vault and/or a pedestal). Such segments of twisted-pair telephone wire may be spliced and/or connected end-to-end, and/or may be connected at only one end thereby creating one or more bridged taps. Regardless of the number, type(s), gauge(s) and/or topology of twisted-pair telephone wires used to construct the example subscriber lines 145 and 146, they will be referred to herein in the singular form, but it will be understood that they may refer to one or more twisted-pair telephone wire segments and may include one or more bridged taps.

As commonly used in the industry, the term “network demarcation point” denotes a location where cabling and/or equipment associated with a service provider (e.g., associated with the CO 105 and/or the DSLAM 115) is physically, electrically and/or communicatively coupled to cabling and/or equipment associated with a customer premises, a subscriber, a user and/or a customer (e.g., the example residential gateway 120 and/or the example DSL modems 130 and 131). Such subscriber cabling and/or equipment are often owned by the customer but may, in some instances, be owned, leased and/or otherwise provided by the service provider. Typically a network demarcation unit (e.g., a network interface device (NID) 150) is located at the network demarcation point (e.g., on the outside of an exterior wall of the customer premises 110) to implement the physical, electrical and/or communicative coupling between the subscriber and service provider sides of the network demarcation point.

In some examples, to reduce and/or eliminate the effects of telephone wiring (not shown) within the customer premises 110, the example residential gateway 120 and/or the example DSL modems 130 and/or 131 are located and/or implemented at and/or within the example NID 150. However, the residential gateway 120 and/or the DSL modems 130, 131 need not be implemented at and/or within the NID 150. For example, the residential gateway 120 and/or the DSL modems 130, 131 could be implemented elsewhere within the customer premises 110. Alternatively, the residential gateway 120 and/or the DSL modems 130, 131 may be partially implemented within the NID 150. For example, a device (e.g., a POTS splitter) may be installed and/or implemented within the NID 150 to isolate the effects of telephone wiring and/or telephones (not shown) located in the customer premises 110 from the residential gateway 120 and/or the DSL modems 130, 131.

The example residential gateway 120 and/or the example DSLAM 115 of FIG. 1 may be used by a person (e.g., a user and/or subscriber) to access any number and/or type(s) of services provided via any number and/or type(s) of servers and/or hosts, two of which are designated at reference numerals 155 and 156. Example hosts 155 and 156 include, but are not limited to, Internet web page servers, IPTV servers, messaging platform servers, VoIP servers, etc. The example hosts 155 and 156 or FIG. 1 are communicatively coupled to the DSLAM 115 via any number and/or type(s) of private and/or public networks, such as the Internet 158.

To access the communication services implemented and/or provided by the example hosts 155 and 156 via the DSLAM 115, any number and/or types of user devices (three of which are designated at reference numerals 160, 161 and 162) may be communicatively coupled to the example residential gateway 120. The example user devices 160-162 of FIG. 1 may be communicatively coupled to the residential gateway 120 via any number and/or types of local area networks (e.g., wired and/or wireless), one of which is designated at reference numeral 165. Example user devices include, but are not limited to, a set-top box 160 (e.g., to access an IPTV service), a personal computer 161 (e.g., to access the Internet and/or to play on-line games), a VoIP phone 162, a router, a smart phone, a personal digital assistant (PDA), etc. The example user devices 160-162 access the services provided and/or implemented by the example hosts 155 and 156 via the LAN 165, the residential gateway 120, the bonded DSL communication path 132, the DSLAM 115 and the Internet 158.

Traditionally, the same DSL line profile has been selected and statically configured for each subscriber line of a bonded DSL service. Moreover, traditionally a DSL line profile is selected without knowledge of the specific applications and/or services that have and/or are being accessed by a subscriber, and without knowledge of error and/or noise conditions of each subscriber line (e.g., due to structural differences between two subscriber lines of a bonded DSL service). For example, if one subscriber line of a bonded DSL service experiences increased errors, traditional methods downgrade all subscriber lines of the bonded DSL service by configuring all of the subscriber lines to a lower data rate and/or by enabling interleaving on all subscriber lines. However, by lowering the transport capabilities of all subscriber lines, the capabilities of the bonded DSL service are degraded more than necessary. For at least these reasons, the application of a common DSL line profile to each subscriber line of a bonded DSL service may lead to increased customer dissatisfaction, lost service provider revenue, decreased numbers of subscribers to which a service may be offered, sold and/or provisioned, increased numbers of customer support calls, increased numbers of technician service calls, etc.

In contrast, the example DSL communication system of FIG. 1 monitors the historical and/or current usage of applications and/or services, and dynamically and individually adjusts the line profile of the subscriber lines (e.g., the example subscriber lines 145 and 146) of a bonded DSL communication path (e.g., the example bonded DSL path 132) to maximize the overall transport capabilities of the bonded DSL path for the applications and/or services that are and/or have been historically used within a customer premises (e.g., the example customer premises 110). For example, when a single subscriber line (e.g., the subscriber line 145) is experiencing increased errors, then only the line profile for that subscriber line 145 is adjusted. If a first application benefits from low latency (e.g., VoIP and/or gaming) while a second application can tolerate higher latency (e.g., IPTV), then the subscriber line 145 experiencing the increased errors may be configured to enable interleaving to reduce the number of errors. Because interleaving increases transport latency, user data for the second application (which is relatively less sensitive to latency) would be transported over the subscriber line 145 configured with interleaving, while user data for the first application (which is more noticeably effected by latency) would be transported over the subscriber line that remains configured without interleaving (e.g., the subscriber line 146). If all applications currently and/or historically used by the bonded lines benefit from low latency, then the subscriber line 145 experiencing the increased errors is configured to a lower data rate to reduce the number of errors. Thus, the example DSL communication system of FIG. 1 seeks to improve (e.g. maximize) the performance of a bonded DSL communication path 132 in view of the applications historically and/or currently accessed with the path 132, and in further view of the actually performance characteristics (e.g., error rates) of the individual subscriber lines 145 and 146 that form the bonded DSL communication path 132.

To manage bonded DSL communication paths (e.g., the example path 132), the example residential gateway 120 of FIG. 1 includes an application layer logger 170, and the example CO 105 of FIG. 1 includes a profile manager 180. When user data is transmitted and/or received by the example residential gateway 120, the example application layer logger 170 records and/or updates statistics regarding the bandwidth usage by each application. For example, for each IP address (e.g., host 155, 156) to which user data is transmitted and/or received, the example application layer logger 170 tracks, estimates and/or computes the average data rate (e.g., over each 15 minute interval). The example application layer logger 170 may also be configured by the example profile manager 180 to block user data associated with one or more IP addresses. User data associated with a particular IP address (e.g., host 155, 156) may be blocked to preserve the performance of higher priority applications and/or services. When user data directed to a blocked host is received at the residential gateway 120, the example application layer logger 170 blocks (e.g., discards) such user data.

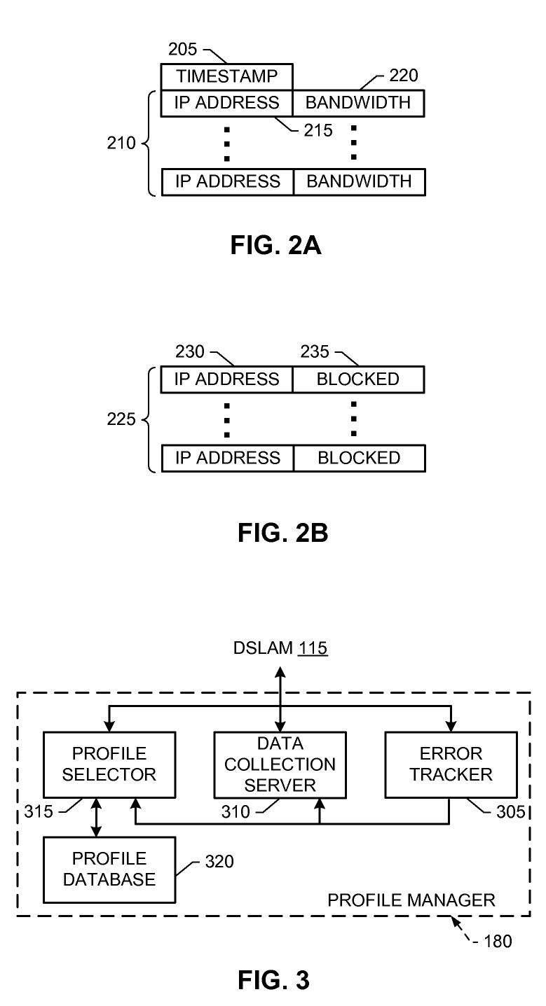

The example application layer logger 170 of FIG. 1 stores collected application usage data in a host table 175. Information concerning blocked hosts (e.g., IP addresses) is also stored in the example host table 175. The example host table 175 of FIG. 1 may be implemented using any number and/or type(s) of data structure(s), memory(-ies) and/or memory devices. Example data structures that may be used to implement the example host table 175 are described below in connection with FIGS. 2A and 2B.

The example application layer logger 170 of FIG. 1 provides the usage data stored in the host table 175 to the example profile manager 180. For example, the profile manager 180 may, periodically and/or aperiodically, query the application layer logger 170 for the usage data 175. Additionally or alternatively, the application layer logger 170 may, periodically and/or aperiodically, send (e.g. push) the usage data 175 to the profile manager 180. While the example application layer logger 170 and the example host table 175 are implemented by the example residential gateway 120, the application layer logger 170 and/or the host table 175 may, additionally or alternatively, be implemented by and/or at the DSLAM 115 and/or the CO 105.

The example profile manager 180 of FIG. 1 collects performance data (e.g., error count data) associated with the subscriber lines (e.g., the subscriber lines 145 and 146) of a bonded DSL path (e.g., the example path 132). When the performance data of a subscriber line degrades to a sufficient degree (e.g., the number of errors over a given time period exceeds a first threshold, or an increase in the number and/or rate of errors exceeds a second threshold), the example profile manager 180 determines how the line profile(s) of any of the subscriber lines 145 and 146 of the bonded DSL communication path 132 should be adjusted. For example, when a single subscriber line (e.g., the subscriber line 145) is experiencing increased errors, then only the line profile for that subscriber line 145 may be adjusted. If a first application benefits from low latency (e.g., VoIP and/or gaming) while a second application can tolerate higher latency (e.g., IPTV), then the subscriber line 145 experiencing the increased errors may be configured to enable interleaving to reduce the number of errors. Because interleaving increases transport latency, user data for the second application may be transported over the subscriber line 145 configured with interleaving, while user data for the first application may be transported over the subscriber line that remains configured without interleaving (e.g., the subscriber line 146). If all applications currently and/or historically used benefit from low latency, then the subscriber line 145 experiencing the increased errors is configured to a lower data rate to reduce the number of errors. Any lower priority application may then be associated with the lower data rate line 145. When there are excessive numbers of errors (e.g., when there are no sets of line profiles that can maintain the performance of all historically and/or currently used applications), the example profile manager 180 may disable one or more applications by preventing transport of data from the host to the CPE at the host and/or by notifying the example application layer logger 170. As described above, the application layer logger 170 subsequently blocks user data associated with those hosts. An example manner of implementing the example profile manager 180 of FIG. 1 is described below in connection with FIG. 3.

FIGS. 2A and 2B illustrate example data structures that may be used to implement the example host table 175 of FIG. 1. The example data structure record of FIG. 2A may be used to store usage data for a particular time period. The example host table 175 may implement more than one of the example records of FIG. 2A to store usage data for more than one time period. To represent a particular time period, the example data structure record of FIG. 2A includes a timestamp field 205. The example timestamp field 205 of FIG. 2A contains one or more numbers, characters and/or alphanumeric strings representative of a start and/or end time of a time period and/or interval, and/or date.

To store usage data, the example data structure record of FIG. 2A includes a plurality of entries 210 for respective ones of a plurality of hosts. To identify a host, each of the example entries 210 of FIG. 2A includes an IP address field 215. The example IP address field 215 of FIG. 2A contains an IP address associated with a particular host and/or server (e.g., one of the example hosts 155, 156 of FIG. 1). To store usage data, each of the example entries 210 of FIG. 2A includes a bandwidth field 220. The example bandwidth field 220 of FIG. 2A contains a value representative of an average amount of data transmitted to and/or received from the host.

The example data structure of FIG. 2B may be used to store host blocking information. The example data structure record of FIG. 2B includes a plurality of entries 225 for a respective ones of a plurality of hosts. To identify a host, each of the example entries 225 of FIG. 2B includes an IP address field 230. The example IP address field 230 of FIG. 2B contains an IP address associated with a particular host and/or server (e.g., one of the example hosts 155, 156 of FIG. 1).

To specify whether user data associated with a host is to be blocked, each of the example entries 225 of FIG. 2B includes a blocked field 235. The example blocked field 235 of FIG. 2B contains a flag and/or value that represents whether user data associated with the host is to be blocked. For example, if the blocked field 235 contains a value ‘TRUE’ (e.g., logic value 1) then user data for the host is to be blocked. The example data structure of FIG. 2B need not contain an entry for each host represented in the example data structure record of FIG. 2B. For example, the example data structure may only list hosts for which data is to be blocked, thereby allowing the example blocked field 235 to be eliminated from the data structure of FIG. 2B.

While example data structures that may be used to implement the example host table 175 of FIG. 1 are illustrated in FIGS. 2A and 2B, the example data structures of FIGS. 2A and/or 2B may be implemented using any number and/or type(s) of other and/or additional entries, fields and/or data. Further, the entries, fields and/or data illustrated in FIGS. 2A and/or 2B may be combined, divided, re-arranged, eliminated and/or implemented in any way. Moreover, the example data structures may include entries, fields and/or data in addition to, or instead of, those illustrated in FIGS. 2A and/or 2B, and/or may include more than one of any or all of the illustrated entries, fields and/or data.

FIG. 3 illustrates an example manner of implementing the example profile manager 180 of FIG. 1. To monitor the performance of subscriber lines, the example profile manager 180 of FIG. 3 includes an error tracker 305. The example error tracker 305 of FIG. 3, periodically and/or aperiodically, collects error count information for each subscriber line of a bonded DSL communication path (e.g., the example lines 145 and 146 of the example path 132 of FIG. 1). When the performance data of a subscriber line sufficiently degrades (e.g., the number of errors per unit time exceeds a first threshold, or an increase in the number or rate of errors exceeds a second threshold), the example error tracker 305 triggers the operation(s) of a data collection server 310 and/or a profile selector 315.

To collect usage data, the example profile manager 180 of FIG. 3 includes the data collection server 310. The example data collection server 310 of FIG. 3 implements and/or includes an Automatic Data exchange (ADX) server to, periodically and/or aperiodically, collect usage data for one or more time intervals (e.g., the example host table 175 of FIG. 1) from, for example, the example residential gateway 120 via the DSLAM 115. The example data collection server 310 analyzes the collected usage data to deduce historical and/or current usage patterns of different applications and/or hosts at the residential gateway 120. For example, the data collection server 310 may determine that the customer premises 110 associated with the residential gateway 120 historically receives three high-definition IPTV channels, uses two different VoIP telephone numbers, and accesses the Internet (e.g., to do web browsing).

To select a DSL line profile for one or more subscriber lines of a bonded DSL communication path (e.g., either or both of the example lines 145 and 146 of FIG. 1), the example profile manager 180 of FIG. 3 includes a profile selector 315 and a profile database 320. The example profile database 320 of FIG. 3 stores one or more DSL line profiles that may be selected by the example profile selector 315 for a subscriber line. DSL line profiles represent different combinations of upstream (e.g., from a customer premises to a CO) data rates, downstream (e.g., from a CO to a customer premises) data rates, error correction parameters, and interleaving parameters. The example profile database 320 may be implemented using any number and/or type(s) of data structures, memory(-ies) and/or memory device(s).

The example profile selector 315 of FIG. 3 analyzes the historical application usage determinations made by the data collection server 310 to select one or more applicable DSL line profiles. For instance, for the example subscriber described above, the example profile selector 315 determines that at least one subscriber line needs to be configured without interleaving to provide a low latency communication path for the VoIP services, but that other historically used services (e.g., IPTV and Internet access) can tolerate the latency associated with an interleaved communication path, if necessary, to keep the overall error rates associated with the bonded DSL communication path at an acceptable level. Moreover, since the subscriber typically accesses three high-definition IPTV channels but has relatively lower upstream data rate requirements, the profile selector 315 may select a data rate combination that includes a higher data rate downstream and a lower data rate upstream, if necessary, to keep the error rates associated with the bonded DSL communication path at an acceptable level. Based on the capabilities of the individual subscriber lines and the application usage information, the example profile selector 315 selects an appropriate DSL line profile for one or more of the subscriber lines. When the historical and/or current bandwidth requirements are greater than a collective transport capability a bonded DSL path can reliably support, the example profile selector 315 will select which application(s) and/or host(s) are to be configured as blocked. The example profile selector 315 configures the DSLAM 115 and/or the residential gateway 120 with the selected DSL line profile(s) and/or the host blocking information.

Because the example error tracker 305, the example data collection server 310, the example profile selector 315 and/or, more generally, the example profile manager 180 of FIG. 3 are continually and/or dynamically monitoring the performance and usage of a bonded DSL communication path, the example profile manager 180 of FIG. 3 enables increased customer satisfaction, increased service provider revenue, increased numbers of subscribers to which a service may be offered, sold and/or provisioned, decreased numbers of customer support calls, and/or decreased numbers of technician service calls for the example DSL communication system of FIG. 1.

While an example manner of implementing the example profile manager 180 of FIG. 1 has been illustrated in FIG. 3, one or more of the elements, processes and/or devices illustrated in FIG. 3 may be combined, divided, re-arranged, omitted, eliminated and/or implemented in any other way. Further, the example error tracker 305, the example data collection server 310, the example profile selector 315, the example profile database 320 and/or, more generally, the example profile manager 180 of FIG. 3 may be implemented by hardware, software, firmware and/or any combination of hardware, software and/or firmware. Further still, the example profile manager 180 of FIG. 3 may include one or more elements, processes and/or devices in addition to, or instead of, those illustrated in FIG. 3 and/or may include more than one of any or all of the illustrated elements, processes and devices.

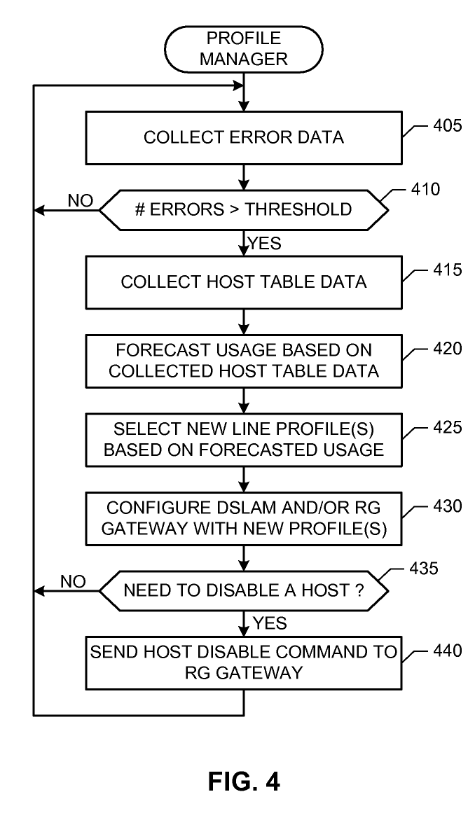

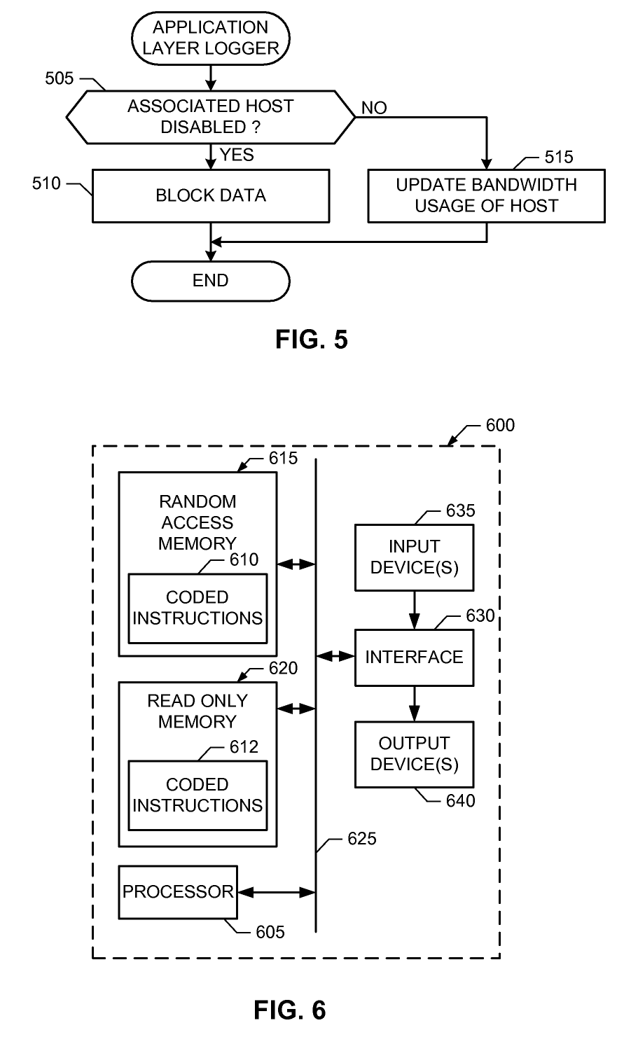

FIG. 4 is a flowchart representative of example machine accessible instructions that may be carried out to implement any or all of the example profile manager 180 of FIGS. 1 and/or 3. FIG. 5 is a flowchart representative of machine accessible instructions that may be carried out to implement the example application layer logger 170 of FIG. 1. The example machine accessible instructions of FIGS. 4 and/or 5 may be carried out by a processor, a controller and/or any other suitable processing device. For example, the example machine accessible instructions of FIGS. 4 and/or 5 may be embodied in coded instructions stored on a tangible medium such as a flash memory, a read-only memory (ROM) and/or a random-access memory (RAM) associated with a processor (e.g., the example processor 605 discussed below in connection with FIG. 6). Alternatively, some or all of the example machine accessible instructions of FIGS. 4 and/or 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example machine accessible instructions of FIGS. 4 and/or 5 may be implemented manually or as any combination of any of the foregoing techniques, for example, any combination of firmware, software, discrete logic and/or hardware. Thus, any or all of the example application layer logger 170, the example profile manager 180, the example error tracker 305, the example data collector server 310, the example profile selector 315, the example profile database 320 and/or the example host table 175 may be implemented by hardware, firmware and/or software. Further, although the example operations of FIGS. 4 and 5 are described with reference to the flowcharts of FIGS. 4 and 5, many other methods of implementing the operations of FIGS. 4 and/or 5 may be employed. For example, the order of execution of the blocks may be changed, and/or one or more of the blocks described may be changed, eliminated, sub-divided, or combined. Additionally, any or all of the example machine accessible instructions of FIGS. 4 and/or 5 may be carried out sequentially and/or carried out in parallel by, for example, separate processing threads, processors, devices, discrete logic, circuits, etc.

The example machine accessible instructions of FIG. 4 begin with a profile manager (e.g., the example error tracker 305 of FIG. 3) collecting error information for the subscriber lines of a bonded DSL communication path (e.g., the example lines 145 and 146 of the example bonded DSL path 132 of FIG. 1) (block 405). If the number of errors for each subscriber line is less than a threshold (block 410), control returns to block 405 to collect new error information.

If the number of errors for any subscriber line of a bonded DSL communication path exceeds a threshold (block 410), the profile manager (e.g., the example data collection server 310 of FIG. 3) collects usage data from an application layer logger (e.g., the example application layer logger 170 and/or the example host table 175 of FIG. 1) for the bonded DSL communication path (block 420). Using any desired forecasting technique(s) (e.g., extrapolation), the data collection server then analyzes the collected usage data and/or previously collected usage data to forecast future usage patterns for one or more applications (block 420).

Based on the forecasted usage pattern(s), the profile manager (e.g., the example profile selector 315 of FIG. 3) selects a profile for each of the subscriber lines of the bonded DSL communication path (block 425) and configures a DSLAM (e.g., the example DSLAM 115 of FIG. 1) and/or a residential gateway (e.g., the example residential gateway 120) based on the selected profile(s) (block 430). Thus, the profiles of any or all of the lines of the bonded pair may change or stay the same.

When the historical and/or current bandwidth requirements are greater than the collective transport capability of a bonded DSL path can reliably support (block 435), the example profile selector selects which application(s) and/or host(s) are to be configured as blocked and configures the residential gateway with the host blocking information (block 440). Control then returns to block 405 to collect new error information.

Returning to block 435, if no hosts are to be blocked (block 435), control returns to block 405 to collect new error information.

The example machine accessible instructions of FIG. 5 begin when user data is received at a residential gateway (e.g., the example residential gateway 120 of FIG. 1). The residential gateway (e.g., the example application layer logger 170) determines whether the user data is directed to a blocked host (block 505). If the user data is directed to a blocked host (block 505), the user data is discarded (e.g., blocked) (block 510). Control then exits from the example machine accessible instructions of FIG. 5.

If the user data is not directed to a blocked host (block 505), the application layer logger updates the bandwidth usage of the host (e.g., updates the example bandwidth field 220 of FIG. 2A associated with the host) (block 515). Control then exits from the example machine accessible instructions of FIG. 5.

FIG. 6 is a schematic diagram of an example processor platform 600 that may be used and/or programmed to implement any portion(s) and/or all of the example application layer logger 170 of FIG. 1 and/or the example profile managers 180 of FIGS. 1 and/or 3. For example, the processor platform 600 can be implemented by one or more processors, processor cores, microcontrollers, DSPs, DSP cores, ARM processors, ARM cores, etc.

The processor platform 600 of the example of FIG. 6 includes at least one programmable processor 605. The processor 605 executes coded instructions 610 and/or 612 present in main memory of the processor 605 (e.g., within a RAM 615 and/or a ROM 620). The processor 605 may be any type of processing unit, such as a processor core, a processor and/or a microcontroller. The processor 605 may execute, among other things, the example machine accessible instructions of FIGS. 4 and/or 5 to implement any or all of the example application layer loggers and/or the example profile managers described herein. The processor 605 is in communication with the main memory (including a ROM 620 and/or the RAM 615) via a bus 625. The RAM 615 may be implemented by DRAM, SDRAM, and/or any other type of RAM device, and ROM may be implemented by flash memory and/or any other desired type of memory device. The example RAM 615 and/or the example ROM 620 may be used to implement the example host table 175 of FIG. 1, and/or the example profile database 320 of FIG. 3. Access to the memory 615 and 620 may be controlled by a memory controller (not shown).

The processor platform 600 also includes an interface circuit 630. The interface circuit 630 may be implemented by any type of interface standard, such as a USB interface, a Bluetooth interface, an external memory interface, serial port, general purpose input/output, etc. One or more input devices 635 and one or more output devices 640 are connected to the interface circuit 630.

Of course the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein may be stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by different, faster, and/or more efficient systems having the same general purpose. Accordingly, replacement devices, standards and/or protocols having the same general purpose are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
collecting data representative of bandwidth usage for two or more applications serviced by a bonded set of subscriber lines;
analyzing historical activity of the two or more applications based on the collected bandwidth usage data; and
selecting a first digital subscriber line (DSL) line profile for a first wire pair in the set of subscriber lines, the set of subscriber lines forming a single DSL communication link.

2. A method as defined in claim 1, further comprising selecting a second DSL line profile for a second wire pair in the set of subscriber lines based on the historical activity.

3. A method as defined in claim 2, wherein the first DSL line profile is different from the second DSL line profile.

4. A method as defined in claim 2, wherein the first DSL line profile is adapted to a first service quality characteristic of a first application, and the second DSL line profile is adapted to a second service quality characteristic of a second application.

5. A method as defined in claim 1, wherein the first DSL line profile is selected based on a performance difference between the first pair and a second wire pair in the set of subscriber lines.

6. A method as defined in claim 1, wherein the first DSL line profile is selected to secure a service quality characteristic for at least one of the applications.

7. A method as defined in claim 1, wherein the bandwidth usage data is collected via a customer-premises DSL modem.

8. A method as defined in claim 1, wherein the collected data comprises an Internet protocol address for each respective one of the two or more applications, and a bandwidth usage value for each respective one of the two or more applications.

9. A method as defined in claim 1, wherein the set of subscriber lines are electrically coupled to a single customer premises.

10. (canceled)

11. A method as defined in claim 1, further comprising disabling a first application to a customer premises to secure a service quality characteristic of a second application.

12. An apparatus comprising:
a data collection server to collect bandwidth usage data for two or more applications delivered by a bonded set of subscriber lines;
a profile selector to select a first digital subscriber line (DSL) line profile for a first wire pair in the bonded set and a second DSL line profile for a second wire pair in the bonded set based on the collected bandwidth usage data, the bonded set forming a single DSL communication link.

13. An apparatus as defined in claim 12, wherein the profile selector is to analyze historical activity of the two or more applications based on the bandwidth usage data, and to select the first and second DSL line profiles based on the historical activity.

14. (canceled)

15. An apparatus as defined in claim 12, further comprising an error tracker to detect when a number of errors per unit of time associated with the first wire pair exceeds a threshold.

16. An apparatus as defined in claim 15, wherein the data collection server collects the bandwidth usage data when the number of errors per unit time exceeds the threshold.

17. An apparatus as defined in claim 12, further comprising an error tracker to detect when an increase in a number of errors associated with the first wire pair exceeds a threshold.

18. An apparatus as defined in claim 12, further comprising a profile database, wherein the profile selector selects the first and second DSL line profiles from the profile database.

19. (canceled)

20. (canceled)

21. (canceled)

22. (canceled)

23. (canceled)

24. An apparatus as defined in claim 12, wherein the profile selector is to select the first and second DSL line profiles to tradeoff a first service quality characteristic of a first application against a second service quality characteristic of a second application.

25. An apparatus as defined in claim 12, wherein the profile selector is to disable a first application to secure a service quality characteristic of a second application.

26. An article of manufacture storing machine readable instructions which, when executed, cause a machine to:
collect data representative of bandwidth usage for two or more applications serviced by a bonded set of subscriber lines;
analyze historical activity of the two or more applications based on the collected bandwidth usage data; and
select a first digital subscriber line (DSL) line profile for a first wire pair in the set of subscriber lines, the set of subscriber lines forming a single DSL communication link.

27. An article of manufacture as defined in claim 26, wherein the machine readable instructions, when executed, cause the machine to select a second DSL line profile for a second wire pair in the set of subscriber lines based on the historical activity, wherein the first DSL line profile is adapted to a first service quality characteristic of a first application, and the second DSL line profile is adapted to a second service quality characteristic of a second application.

28. An apparatus comprising:
a first digital subscriber line (DSL) modem to couple the apparatus to a DSL access multiplexer (DSLAM) via a first subscriber line;
a second DSL modem to couple the apparatus to the DSLAM via a second subscriber line, the first subscriber line bonded to the second subscriber line to form a single DSL communication link; and
an application layer logger to receive user data directed to a host, to determine whether the user data directed to the host is blocked, and to update a bandwidth usage associated with the host when the user data is not blocked.

29. An apparatus as defined in claim 28, wherein the first DSL modem is to receive a DSL line profile via the DSLAM, the DSL line profile selected based on the bandwidth usage.

30. An apparatus as defined in claim 28, further comprising a host table to store the updated bandwidth usage and an Internet protocol address associated with the host.

31. An apparatus as defined in claim 28, wherein the apparatus comprises a residential gateway.

32. An apparatus as defined in claim 28, wherein the apparatus comprises a network interface device.
